(19) United States
(12) Patent Application Publication
(10) Pub. No.: US 2010/0165182 A1
(43) Pub. Date: Jul. 1, 2010

(54) COMBINATION DEVICE OF SPEAKER AND CAMERA OPTICAL SYSTEM

(75) Inventor: Ronald Yuan, Beijing (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/376,937

(22) PCT Filed: Aug. 6, 2007
(86) PCT No.: PCT/IB07/53091

§ 371 Date: Feb. 9, 2009

(30) Foreign Application Priority Data
Aug. 8, 2006 (EA) 200610109185.5
Aug. 6, 2007 (IB) PCT/IB2007/053091

(51) Int. Cl. H04N 5/225

(52) U.S. Cl. 348/374; 348/E05.024

(57) ABSTRACT

In the device according to this invention, a vibrating diaphragm and a magnetic conduction plate are improved, so that the vibrating diaphragm of the speaker, under the action of magnetic force excited by different electrical signals, can convert an acoustoelectric signal into voice, can resonate together with a coil, and can be as a movable lens to constitute an optical focusing/zooming system together with lens of the camera optical system, respectively, so that the space of the mobile terminal occupied by the combination device can be saved, and the sound quality of the speaker also can be improved.

### FIELD OF THE INVENTION

The present invention relates to a device comprising: a magnetic circuit system including a magnetic loop, an upper magnetic conduction plate, and a low magnetic conduction plate, said low magnetic conduction plate comprising a hollow structure; and an optical system including a lens and a photo sensitive element.

### BACKGROUND OF THE INVENTION

With development of the microelectronic technique and the radio communication technique, mobile phones with various functions has become commercially available, such as those with game playing function, photographing function, and color screen function. The mobile phones with various interface functions may not only provide an excellent usability for the users, but also increase added value of usage. In general, the conventional mobile phone may have integrated at least a speaker and a vibratable unit. The speaker is used for converting electrical signal into a sound signal (e.g. music etc.) voice. The vibratable unit (vibrator) is mainly used for the mobile phone working in a vibrating mode. When a call or a message reaches, vibration occurs to call the user's attention.

Currently, the mobile phone more popular in the market is also integrated with a charge coupled (CCD) camera, which may comprise a digital scaling function. Since the optical focusing system of the conventional digital camera with excellent performance occupies a larger space and requires a complicated mechanical system and a complicated driving algorithm, it is difficult to appropriately apply the above-mentioned optical focusing system to the mobile phone having limited space.

A speaker device used with a camera is disclosed in GB patent application No. 2405550, published on Mar. 2, 2005 and entitled “Speaker Device”, for reducing the space of the mobile phone occupied by the camera and the speaker. According to this patent application, the disclosed device comprises a lens, a lens mounting plate, and a set of bending strain pieces, such as piezoelectric pieces. The position of the lens can be adjusted by deformation of the set of strain pieces generated under the action of controlling voltage signals so as to achieve focusing. The lens mounting plate, as a vibrating diaphragm of the speaker, can generate voice.

However, the bending strain pieces composed of piezoelectric pieces in No. 2405550 can not generate enough displacement (it is disclosed in the above-mentioned patent application that the displacement is about 100 μm). Therefore, the effect of the speaker will be limited due to limitation of amplitude of vibration, and excellent low frequency effect can not be obtained, such that a response having an sufficiently wide frequency band can not be achieved. In addition, the bending strain pieces composed of piezoelectric pieces or magnetic striction device is commercially unavailable and have high cost, and because electric load of the bending strain pieces (mainly including capacitive load, with high input impedance) is different from that of conventional moving-coil type speakers (input impedance is about 8 ohms) which are widely used at present, a driving circuit for it can not directly be adapted to low-voltage audio driving circuit of existing mobile phones (or miniature portable equipments), and thus an auxiliary circuit, such as DC-DC booster circuit, is required.

Accordingly, in order to accommodate, a trend that a mobile phone is required to have various functions, be ultra-thin, and be miniaturized, it is necessary to provide a new combination device of a speaker and a camera so as to improve combination performance of the speaker and the camera.

### OBJECT AND SUMMARY OF THE INVENTION

An object of this invention is to provide a new device to improve performance of the speaker and the camera optical system.

The above object of this invention may be achieved by providing a device comprising:

a magnetic circuit system comprising a magnetic loop, an upper magnetic conduction plate, and a low magnetic conduction plate, said low magnetic conduction plate comprising a hollow structure; a vibrating system comprising vibratable diaphragm and a coil, said vibratable diaphragm comprising a top dome and being at least partially made of transparent material; and an optical system including a lens and a photo-sensitive element; wherein said vibratable diaphragm is adapted and arranged, together with the lens in said optical system to constitute an optical focusing system.

In an embodiment, said device further comprises a printed circuit board and an electrode/contact, wherein one end of said coil is connected with said corrugated rim, and the other end thereof is fixed to said printed circuit board through a retractable wire loop, and said electrode/contact is an interface of said photo-sensitive clement and said coil with an outer controlling circuit.

When direct current signals are applied to said electrode/contact, said coil, under the action of static magnetic force generated in said magnetic circuit system, drives said top dome through said corrugated rim to displace, and said displacement or movement is determined by the driving algorithm provided by the outer controlling circuit, and is controlled by adjusting voltage/current intensity of the direct current supplied from the electrode/contact, so that said top dome, as a movable lens, together with the lens in said optical system constitutes the optical zooming system of said camera.

When low frequency acoustoelectric signals are applied to said electrode/contact, said coil, under the action of alternative magnetic force generated in said magnetic circuit system, drives said compound vibrating diaphragm to vibrate, and the sound is propagated by air medium, thereby achieving a speaker function.

When alternative electrical signals are applied to said electrode/contact, said coil, under the action of magnetic force generated in the magnetic circuit system, drives said top dome through said corrugated rim to reciprocate, so that vibration is generated, and the corresponding vibrating frequency is determined by the driving signal frequency applied to the coil.

The frequency of said alternative electronic signal is identical with the resonance frequency of said vibrating system, the vibrating force generated by said vibrating system drives a housing provided with said combination device to vibrate, thereby achieving a speaker function.

In the device of the speaker and the camera optical system according to this invention, a vibrating diaphragm and a magnetic conduction plate are improved, so that the vibrating diaphragm of the speaker, under the action of magnetic force excited by different electrical signals, can convert an acoustoelectric signal into sound, can resonate together with a coil, and in adapted as a movable lens to constitute an optical focusing/zooming system together with lens of the camera optical system, respectively, so that the space of the mobile terminal occupied by the vibrating diaphragm and the magnetic conduction plate can be effectively saved.

Further, since the top dome of the compound vibrating diaphragm is made of hard material, a lower system resonance frequency, including the mass of the coil, can be achieved to reproduce low frequency component of the sound signal, so that a smooth acoustic pressure level response can be obtained within a wider frequency band range. Moreover, the hard top dome can solve the problem of acoustic pressure frequency response sink caused due to vibration of the high frequency component of the voice, so that sound quality of the speaker can be effectively improved.

The other objects and effects of the invention will become apparent and more readily appreciated from the following description and the claims, taken in conjunction with the accompanying drawings.

### BRIEF DESCRIPTION OF THE DRAWINGS

FIG. 1 shows three-dimensional views of a combination device of a speaker and a camera optical system according to an embodiment of this invention, in which FIG. 1(a) is a three dimensional top view and FIG. 1(b) is a three dimensional bottom view;

FIG. 2 shows a three-dimensional exploded view of the combination device of the speaker and the camera optical system according to the embodiment of this invention;

FIG. 3 shows a three dimensional cross-sectional view of the combination device of the speaker and the camera optical system according to the embodiment of this invention; and

FIG. 4 shows a cross-sectional schematic view of the combination device of the speaker and the camera optical system according to the embodiment of this invention.

### DESCRIPTION OF EMBODIMENTS

In the figures, the same reference numbers indicate the similar or corresponding characteristics or functions throughout.

In the device of a speaker and the camera optical system according to this invention, a vibrating diaphragm and a magnetic conduction plate are improved, so that the vibrating diaphragm of the speaker, under the action of magnetic force excited by different electrical signals, can convert an acoustoelectric signal into voice, can resonate together with a coil, and can be as a movable lens to constitute an optical focusing/zooming system together with lens of the camera optical system, respectively.

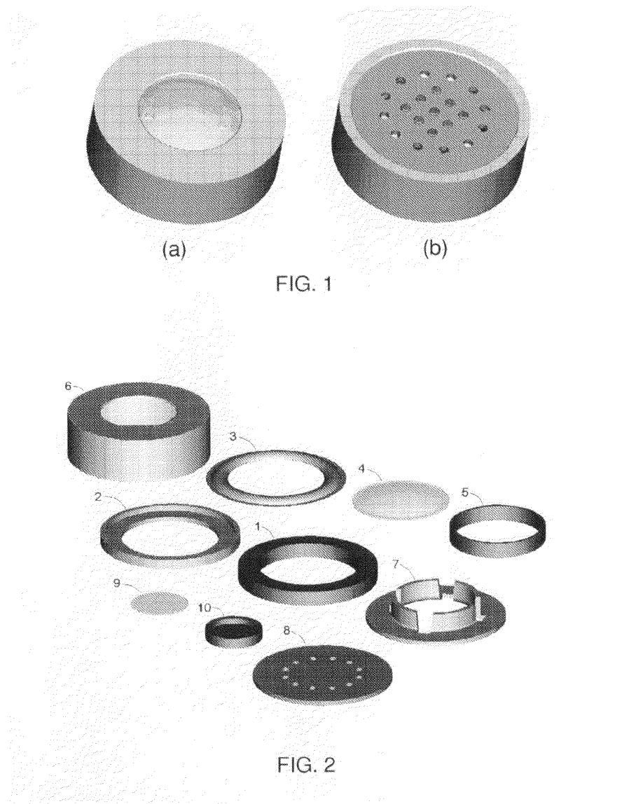

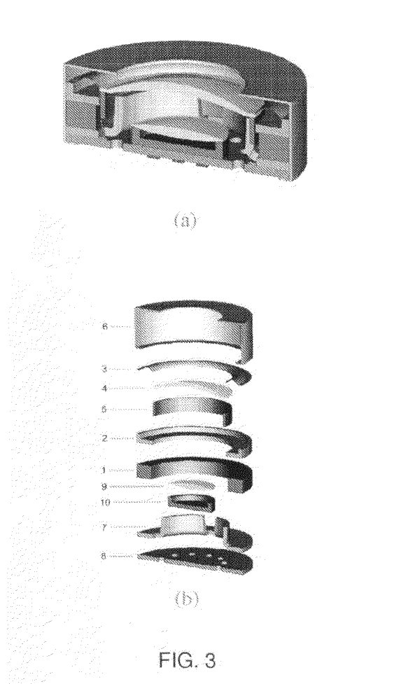

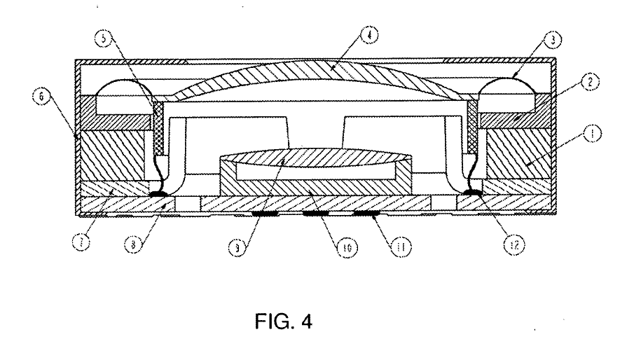

FIG. 1 shows three dimensional views of a device of a speaker and a camera optical system according to an embodiment of this invention, in which FIG. 1(a) is a three dimensional top view and FIG. 1(b) is a three dimensional bottom view. FIG. 2 shows a three dimensional exploded view of the combination device of the speaker and the camera optical system according to the embodiment of this invention. FIG. 3 shows a three dimensional cross-sectional view of the combination device of the speaker and the camera optical system according to the embodiment of this invention. FIG. 4 shows a cross-sectional schematic view of the combination device of the speaker and the camera optical system according to the embodiment of this invention. The structure and operating principle of the combination device of the speaker and the camera optical system according to this invention will be explained in details by referring to FIGS. 1-4.

As shown in FIGS. 1-4, the device of the speaker and the camera optical system according to this invention is provided in a housing 6, and comprises a magnetic circuit system, a vibrating system, and an optical system.

The magnetic circuit system comprises a magnetic loop 1, an upper magnetic conduction plate 2, and a low magnetic conduction plate 7. The magnetic loop 1 may be made of standard permanent magnet material, such as rare earth alloy magnet (including NdFeB etc.). The upper magnetic conduction plate 2 and the low magnetic conduction plate 7 may be made of soft magnet material, such as cold rolled silicon steel, iron-nickel alloy, and ingot iron. The low magnetic conduction plate 7 has a hollow structure, so that light ray can pass through the low magnetic conduction plate 7. The magnetic loop 1, the upper magnetic conduction plate 2, and the low magnetic conduction plate 7 are combined with each other by bonding or a clamping force supplied from the housing 6.

The vibrating system comprises a compound vibrating diaphragm and a coil 5. The compound vibrating diaphragm comprises a top dome 4 and a corrugated rim 3 (i.e. a hanging system). The top dome 4 is at least partially made of hard transparent material, such as glass and/or polycarbonate. The corrugated rim 3 in the present case is made of soft material, such as silica gel and polyurethane. The corrugated rim 3 and the top dome 4 are connected with each other by bonding or insertion-injection molding to constitute the compound vibrating diaphragm.

The optical system comprises a lens 9 and a photosensitive element 10. The lens 9 may be a fixed lens or a movable lens. The photosensitive element 10 may be a charge coupled digital device or other photosensitive devices. In the specific embodiments of the optical system, a plurality of lens can be provided for adapting to various applications. The combination device further comprises a printed circuit board 8 and an electrode/contact 11. The printed circuit board 8 is connected with the electrode/contact 11 via the printed circuit board. The electrode/contact 11 is an interface of the photosensitive element 10 and the coil 5 with an outer controlling circuit.

In the above device, the free end of the coil 5 may be fixed to the printed circuit board 8 through a wire loop that is fixed to the printed circuit board 8, for example, by welding spot 12. The wire loop is retractable, so that the free end of the coil 5 can freely move. The other end of the coil 5 is connected with the corrugated rim 3 by bonding or welding. The circumference of the corrugated rim 3 is bonded to the upper magnetic conduction plate 2. The magnetic circuit system, the vibrating system, and the optical system after being fitted are inserted into the housing 6, and then the opening of the housing is closed, thereby forming a combination device.

When direct current signals are applied to the electrode/contact 11, the coil 5, under the action of static magnetic force generated by the magnetic circuit system, drives or moves or displaces the top dome 4 through the corrugated rim 3. Since the top dome 4 is made of transparent material, the optical signal can pass through the transparent top dome 4 and the hollow low magnetic conduction plate 7 to reach the photo-sensitive element 10. At this time, the top dome 4, as a movable lens, is fitted with the lens 9, that is, to form the optical focusing/zooming system of the camera. The accurate position of the movable lens (i.e. the top dome 4) can be determined by the driving algorithm of the coil 5, and the offset of the movable lens is controlled by adjusting voltage/current intensity of the direct current supplied from the electrode/contact 11.

When low frequency acoustoelectric signals are applied to the electrode/contact 11, the coil 5, under the action of alternative magnetic force generated in the magnetic circuit system, drives the top dome 4 through the corrugated rim 3 to vibrate. Thereby generating sound and that may propagate through air medium. Since the corrugated rim 3 is made of softer rubber material, and the top dome 4, as a vibrating diaphragm, is made of hard material, a lower system resonance frequency of the vibrating system including the mass of the coil, can be achieved to reproduce low frequency component of the sound signal, so that a smooth acoustic pressure level response can be obtained within a wider frequency band range. Moreover, the hard top dome can solve the problem of acoustic pressure frequency response sink caused due to vibration of the high frequency component of the voice, so that sound quality of the speaker can be effectively improved.

When alternative electrical signals are applied to the electrode/contact 11, the coil 5, under the action of magnetic force generated in the magnetic circuit system, drives the top dome 4 through the corrugated rim 3 to reciprocate, so that vibration is generated. The generated vibrating frequency can be determined by the driving signal frequency applied to the coil. When the frequency of the alternative electronic signal is identical with the resonance frequency of the vibrating system composed of the coil 5, the top dome 4, and the corrugated rim 3, the system resonance generates a strong vibrating force to drive the housing provided with this combination device to vibrate.

The resonance frequency of the above vibrating system can be basically determined by the following formula (international system of units MKS is used):

f²*c*(m₁+m₂)*39≈1

wherein, f is the resonance frequency of the vibrating system, c is the compliance coefficient of the corrugated rim, m₁ is the mass of the top dome, and m₂ is the mass of the coil. For a typical example, the coil having a weight of about 150 mg (the copper wire having a wire diameter of about 90 μm and a length of 2.7 m) is used, the lens weighs about 100 mg (the diameter of the lens being about 8 mm, and the average thickness of the lens being about 1 mm), the corrugated rim has a compliance coefficient of 4.5 mm/N, so that the system resonance frequency of about 150 Hz may be obtained.

This components of the device of the speaker and the camera optical system, may be sufficient for driving the housing to vibrate without requiring an additional vibrator, so that space may be saved. Furthermore according to this invention, establishing time of vibration may be shortened. Usually, the time required for accelerating a motor of a conventional motor-driven vibrator to stably rotate needs tens of milliseconds. In contrast the vibrating system according to this invention only takes several milliseconds to establish stable vibration, so that vibration driven by an event in a game playing mode can be simulated so as to improve amusement effects.

Generation of the sound signal, determination of the offset when the movable lens being focused or zoomed, and the vibrating frequency of the mass block may be determined by the corresponding driving algorithm of the coil. The driving algorithm of the coil may be achieved by programming chips (i.e. programmable integrated circuits) in the outer controlling circuit or master controlling chips in the mobile equipment. The driving interface circuit of the coil may have a compatibility with most of conventional audio-frequency amplifying circuits, without requiring an additional DC-DC booster circuit.

The combination device of the speaker and the camera optical system according to this invention may be applied not only to the mobile phone, but also to other portable type terminals, such as personal digital assistant, portable camera, or other handheld consumer electronic products. The camera mentioned in this invention may be any other equipment that needs optical focusing/zooming function, such as a video camera.

The foregoing embodiments and advantages are merely exemplary and are not to be construed as limiting the present invention. The device of the speaker and the camera optical system used in the mobile terminals according to the present invention may be modified without departing from the spirit and scope of the present invention. Therefore, the protection scope of the present invention should be defined by the appended claims.

1. A device comprising:
a magnetic circuit system comprising a magnetic loop, an upper magnetic conduction plate, and a low magnetic conduction plate, said low magnetic conduction plate comprising a hollow structure;
a vibrating system comprising vibratable diaphragm and a coil, said vibratable diaphragm comprising a top dome being at least partially made of transparent material; and
an optical system including a lens and a photo-sensitive element;
wherein said vibratable diaphragm is adapted and arranged, together with the lens in said optical system to constitute an optical focusing system.

2. The device according to claim 1, further comprising a printed circuit board and an electrode/contact, wherein the vibratable diaphragm comprises a corrugated rim and wherein a first end of said coil is connected with said corrugated rim, and a second end of the coil is fixed to said printed circuit board through a retractable wire loop, and wherein said electrode/contact is an interface of said photo-sensitive element and said coil to an outer controlling circuit.

3. The device according to claim 2, wherein said coil, under the action of static magnetic force generatable in the magnetic circuit system, is adapted to move said top dome through said corrugated rim to displace, wherein the movement is determined by the driving algorithm provided by the outer controlling circuit, and is controllable by adjusting voltage/current intensity of a direct current suppliable from the electrode/contact, so that said top dome together with the lens in said optical system constitutes the optical focusing system.

4. The device according to claim 2, wherein when low frequency acoustoelectric signals are applied to said electrode/contact, said coil, under the action of alternative magnetic force generatable in said magnetic circuit system, is adapted to drive said top dome through said corrugated rim to vibrate.

5. The device according to claim 2, wherein when alternative electrical signals are applied to said electrode/contact, said coil, under the action of magnetic force generatable in the magnetic circuit system, is adapted to drive said top dome through said corrugated rim to reciprocate.

6. The device according to claim 5, wherein the frequency of said alternative electronic signal is identical with the resonance frequency of said vibrating system, the vibrating force generated by said vibrating system drives a housing provided with said combination device to vibrate, thereby achieving a speaker function.

7. The device according to claim 6, wherein the resonance frequency of said vibrating system is substantially determined by the compliance coefficient of said corrugated rim and the mass sum of said coil and said top dome.

8. A mobile terminal equipment including the device according to claim 1.
